(19) United States
(12) Patent Application Publication
(10) Pub. No.: US 2025/0341800 A1
(43) Pub. Date: Nov. 6, 2025

(54) IMAGE FORMING APPARATUS, IMAGE FORMING METHOD, AND RECORDING MEDIUM

(71) Applicants: Taichi URAYAMA, Kanagawa (JP); Shinichi AKATSU, Kanagawa (JP); Daisuke TAKAHASHI, Kanagawa (JP); Tetsuo TOKUDA, Tokyo (JP); Tamaki AKAIKE, Kanagawa (JP); Takayuki ISAWA, Kanagawa (JP); Atsushi NAGATA, Kanagawa (JP)

(72) Inventors: Taichi URAYAMA, Kanagawa (JP); Shinichi AKATSU, Kanagawa (JP); Daisuke TAKAHASHI, Kanagawa (JP); Tetsuo TOKUDA, Tokyo (JP); Tamaki AKAIKE, Kanagawa (JP); Takayuki ISAWA, Kanagawa (JP); Atsushi NAGATA, Kanagawa (JP)

(21) Appl. No.: 19/189,292

(22) Filed: Apr. 25, 2025

(30) Foreign Application Priority Data
May 1, 2024 (JP) 2024-074419

(51) Int. Cl. G03G 15/00; G03G 15/16; G03G 21/14

(52) U.S. Cl. CPC G03G 15/5041; G03G 15/1605; G03G 21/14; G03G 2215/00042

(57) ABSTRACT

An image forming apparatus includes: an image bearer to adhere toner on a surface of the image bearer to form a toner image of the image bearer according to image data in printing job data; a detector to detect an amount of the toner adhered on the surface of the image bearer; circuitry configured to: determine an adjustment operation to adjust an image formation condition to form the toner image on the image bearer based on job information in the printing job data; perform the adjustment operation to adjust the image formation condition based on the amount of toner detected by the detector; and exclude a predetermined operation from the adjustment operation when the job information satisfies a predetermined condition.

### CROSS-REFERENCE TO RELATED APPLICATION

This patent application is based on and claims priority pursuant to 35 U.S.C. § 119(a) to Japanese Patent Application No. 2024-074419, filed on May 1, 2024, in the Japan Patent Office, the entire disclosure of which is hereby incorporated by reference herein.

### BACKGROUND

### Technical Field

The present embodiment relates to an image forming apparatus, an image forming method, and a recording medium.

### Related Art

According to an image forming apparatus of an electrophotographic printing type, image density adjustment (process control) is performed at a predetermined timing, such as at the time of power-on or at the time of execution of printing, to keep image density constant during printing. For image forming apparatuses mainly for office use, preferably, “waiting time” (herein, the time taken for printing to be allowed after power on or the time taken for printing to be allowed after recovery from energy-saving mode) is shortened.

### SUMMARY

The present disclosure described herein provides an image forming apparatus includes: an image bearer to adhere toner on a surface of the image bearer to form a toner image of the image bearer according to image data in printing job data; a detector to detect an amount of the toner adhered on the surface of the image bearer; circuitry configured to: determine an adjustment operation to adjust an image formation condition to form the toner image on the image bearer based on job information in the printing job data; perform the adjustment operation to adjust the image formation condition based on the amount of toner detected by the detector; and exclude a predetermined operation from the adjustment operation when the job information satisfies a predetermined condition.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 illustrates an exemplary image forming apparatus;

FIG. 2 illustrates an exemplary hardware configuration of a printer;

FIG. 3 illustrates exemplary functional blocks of the printer;

FIG. 4 illustrates an exemplary toner pattern transferred to an intermediate transfer belt;

FIG. 5 is a flowchart illustrating an exemplary adjustment operation including all operations;

FIG. 6 is a flowchart illustrating an exemplary adjustment procedure;

FIG. 7 is a flowchart illustrating an exemplary adjustment operation excluding a predetermined operation;

FIG. 8 illustrates an exemplary functional configuration of a system controller;

FIG. 9 is a flowchart illustrating an exemplary adjustment procedure;

FIG. 10 illustrates an exemplary functional configuration of a system controller; and

FIG. 11 is a flowchart illustrating an exemplary adjustment procedure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of an image forming apparatus, an image forming method, and a program will be described in detail below with reference to the accompanying drawings.

### First Embodiment

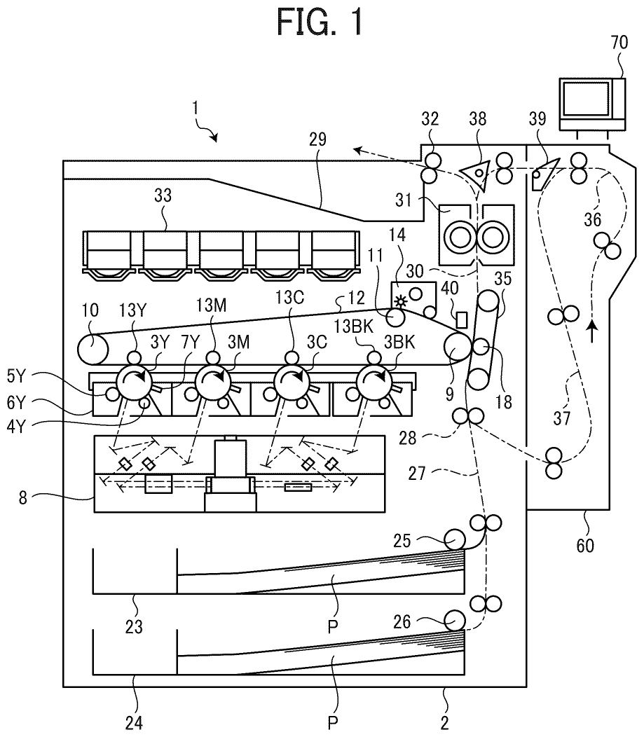

FIG. 1 illustrates, as an example, an image forming apparatus 1 according to a first embodiment. The image forming apparatus 1 includes a printer 2, a reverser 60, and an operation panel 70. The above-described constituents are connected communicably through a communication line or a communication network.

The printer 2 receives printing job data from a digital front end (DFE), a personal computer (hereinafter, referred to as a “PC”), a scanner, or a facsimile. Then, the printer 2 performs printing in accordance with an execution instruction based on the received printing job data or an operation from a user through the operation panel 70. Note that the printing job data includes job information indicating job attributes, such as the number of copies, the number of pages for printing, sheet type, and print type, and image data. The sheet type includes information on plain paper, glossy paper, matte paper, or uneven paper. The print type includes information on color printing or monochrome printing and single-sided printing or double-sided printing.

FIG. 1 includes a conceptual cross-sectional view of the printer 2 and the reverser 60. Four drum-shaped photoconductors 3Y, 3M, 3C, and 3BK as image bearers are horizontally disposed side by side at regular intervals at the center inside the printer 2. The indices Y, M, C, and BK for 3Y, 3M, 3C, and 3BK represent yellow, magenta, cyan, and black colors, respectively. Hereinafter, the indices will be omitted as appropriate.

For example, the photoconductor 3Y has a structure in which an organic semiconductor layer as a photoconductive material is provided on the surface of an aluminum cylinder having a diameter of approximately 30 to 100 mm, and is driven rotationally clockwise in FIG. 1. For an electrostatic photography process, image formers, such as a charging roller 4Y, a developing device 6Y including a developing roller (hereinafter, also referred to as a “developing sleeve”) 5Y as a developer bearer, and a cleaning device 7Y, are disposed in order around the lower side of the photoconductor 3Y. The photoconductor 3Y and the image formers are integrally housed in a single casing, forming a process cartridge. The process cartridge is detachably attached to the printer 2. Note that the photoconductors 3M, 3C, and 3BK for magenta, cyan, and black images, respectively, are similar to the photoconductor 3Y, except that toners used are different in color.

An exposure device 8 is provided in order to form an electrostatic latent image, below the process cartridges. The exposure device 8 scans, with laser beams corresponding one-to-one to yellow image data, magenta image data, cyan image data, and black image data, the photoconductors 3Y, 3M, 3C, and 3BK each charged uniformly by the corresponding charging roller 4. Elongate spaces (slits) are each ensured between one of the charging rollers 4 and the corresponding developing roller 5 such that the photoconductors 3Y, 3M, 3C, and 3BK are irradiated one-to-one with the laser beams emitted from the exposure device 8. Although the exposure device 8 of a laser scanning type including a laser beam source and a polygon mirror is provided, an exposure device including a light emitting diode (LED) array and image forming optics in combination can be also used.

An intermediate transfer belt 12, which is supported by a plurality of rollers 9, 10, and 11 and is driven rotationally counterclockwise in FIG. 1, is provided as a toner pattern bearer above the photoconductors 3Y, 3M, 3C, and 3BK. The intermediate transfer belt 12 serves as a toner pattern bearer. When the toner pattern on each photoconductor 3 is directly detected, the photoconductors 3 each serve as a toner pattern bearer. When the toner image on each photoconductor 3 is directly transferred to a recording medium, such as a sheet, which is being conveyed, to form a toner pattern on the recoding medium, the recoding medium serves as a toner pattern bearer. The intermediate transfer belt 12 is common to the photoconductors 3Y, 3M, 3C, and 3BK and is disposed substantially horizontally and flat to have contact with part of each of the photoconductors 3Y, 3M, 3C, and 3BK after their developing processes.

Transfer rollers 13Y, 13M, 13C, and 13BK are provided, on the inner circumferential side of the intermediate transfer belt 12, counter to the photoconductors 3Y, 3M, 3C, and 3BK, respectively. For example, a cleaning device 14 is provided, on the outer circumferential side of the intermediate transfer belt 12, counter to the roller 11. The cleaning device 14 removes unnecessary toner remaining on the surface of the intermediate transfer belt 12. For example, the intermediate transfer belt 12 is made of a resin film or rubber as a base having a thickness of 50 to 600 μm and has a resistance value such that the respective toner images on the photoconductors 3Y, 3M, 3C, and 3BK can be transferred to the intermediate transfer belt 12.

A toner image creator including the photoconductors 3, the charging rollers 4, the developing devices 6, the cleaning devices 7, and the exposure device 8 creates a toner image on each photoconductor 3. Then, the respective toner images on the photoconductors 3 are transferred by the corresponding transfer rollers 13 so as to be superimposed on the intermediate transfer belt 12.

In the printer 2, a plurality of stepwise drawable sheet feeding cassettes, in the present example, two stepwise drawable sheet feeding cassettes 23 and 24 are disposed below the exposure device 8. Sheets P as recording media housed in the sheet feeding cassettes 23 and 24 are each selectively fed by the corresponding sheet feeding roller 25 or 26. The fed sheet P is conveyed almost vertically on a conveyance path 27 to a secondary transfer position.

An endless conveying belt 35 is disposed on a lateral side of the intermediate transfer belt 12. A secondary transfer roller 18 as a secondary transferrer is provided, inside the loop of the conveying belt 35, counter to the roller 9 as one of the rollers supporting the intermediate transfer belt 12. The roller 9 and the secondary transfer roller 18 are pressed against each other through the intermediate transfer belt 12 and the conveying belt 35 such that a predetermined transfer nip is formed.

A registration roller pair 28 for adjusting the timing of sheet feeding to the secondary transfer position is provided to the conveyance path 27 upstream of the secondary transfer position. A conveyance ejection path 30, which is continuous with the conveyance path 27 and leads to an ejected-sheet stacker 29 on the upper side of the printer 2, is formed above the secondary transfer position.

A fixing device 31 including a fixing roller and a pressure roller and a sheet ejection roller pair 32 are disposed on the conveyance ejection path 30.

In the printer 2, a toner container housing 33, which contains yellow, magenta, cyan, and black toners for the photoconductors 3Y, 3M, 3C, and 3BK and can supply each toner to the corresponding developing device 6 by pumping, is provided in a space below the ejected-sheet stacker 29.

An operation to form an image on a sheet P by the image forming apparatus 1 having the above-described configuration will be described.

First, image data included in printing job data is converted into an output image signal and then the output image signal is transmitted to the exposure device 8.

The exposure device 8 irradiates the surface of the photoconductor 3Y uniformly charged by the charging roller 4Y with a laser beam corresponding to yellow image data emitted from a semiconductor laser, so that an electrostatic latent image is formed on the photoconductor 3Y. The electrostatic latent image is developed with yellow toner under development processing by the developing device 6Y, so that a visible image is obtained. Then, due to the transfer operation of the transfer roller 13Y, the visible image is transferred onto the intermediate transfer belt 12 running in synchronization with the photoconductor 3Y.

Similarly, such latent image formation, development, and transfer operations are performed in order to each of the photoconductors 3M, 3C, and 3BK with certain timing. As a result, a yellow toner image, a magenta toner image, a cyan toner image, and a black toner image superimposed in order are borne as a full-color toner image on the intermediate transfer belt 12 and then are conveyed.

On the other hand, a sheet P is fed from either of the sheet feeding cassettes 23 and 24 and then is conveyed to the registration roller pair 28 through the conveyance path 27. The sheet P is sent out from the registration roller pair 28 with right timing to the full-color toner image on the intermediate transfer belt 12. Then, the full-color toner image on the intermediate transfer belt 12 is transferred onto the sheet P due to the operation of the secondary transfer roller 18.

The sheet P to which the full-color toner image is transferred is conveyed to the fixing device 31 by the conveying belt 35. Then, after fixing processing by the fixing device 31, the sheet P is ejected on the ejected-sheet stacker 29 by the sheet ejection roller pair 32.

For double-sided printing, a switch claw 38 is switched to guide the sheet P after fixing to a reverse path 36. Then, a switch claw 39 is switched to refeed the reversed sheet P to the registration roller pair 28 through a sheet refeeding path 37, so that the sheet P is upside down. In this case, a toner image for an image on a back face is formed and then is borne on the intermediate transfer belt 12. Then, the toner image is transferred to the back face (second face) of the sheet P. After fixing processing by the fixing device 31, the sheet P is ejected on the ejected-sheet stacker 29 by the sheet ejection roller pair 32.

The case of full-color printing has been given above. Even in monochrome printing with a particular color or a black color, a similar operation is performed although not all the photoconductors are used.

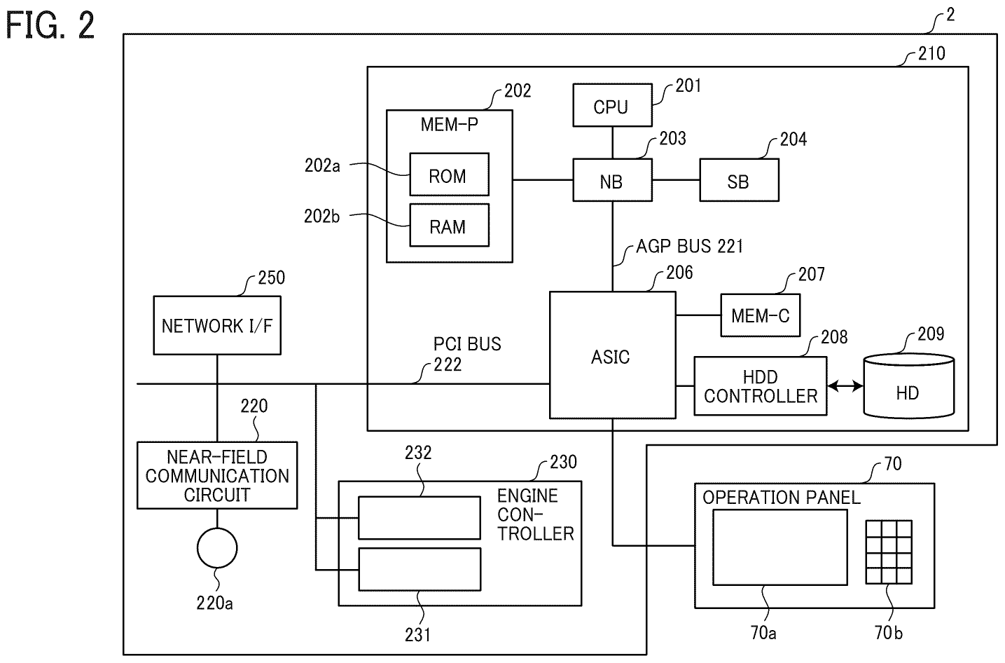

FIG. 2 illustrates an exemplary hardware configuration of the printer 2.

The printer 2 includes a controller 210, a near-field communication circuit 220, an engine controller 230, the operation panel 70, and a network interface (I/F) 250.

The controller 210 includes a central processing unit (CPU) 201 as a main part of a computer, a system memory (MEM-P) 202, a northbridge (NB) 203, a southbridge (SB) 204, an application specific integrated circuit (ASIC) 206, a local memory (MEM-C) 207 as a storage, a hard disk drive (HDD) controller 208, and a hard disk (HD) 209 as a storage.

Note that a solid state drive (SSD) may be used as a storage.

The NB 203 and the ASIC 206 are connected through an accelerated graphics port (AGP) bus 221.

The CPU 201 serves as a controller that controls the entire image forming apparatus 1 including the printer 2. The NB 203 serves as a bridge for connecting the CPU 201, the MEM-P 202, the SB 204, and the AGP bus 221, and includes a memory controller that controls writing to the MEM-P 202, a peripheral component interconnect (PCI) master, and an AGP target.

The MEM-P 202 includes a read only memory (ROM) 202a serving as a memory for storing a program and data that implement each function of the controller 210, and a random access memory (RAM) 202b to be used for expanding such a program or data or as a drawing memory at the time of memory printing. Note that the program stored in the RAM 202b may be recorded, in an installable file format or in an executable file format, on a computer-readable recording medium, such as a compact disc read only memory (CD-ROM), a compact disc recordable (CD-R), or a digital versatile disc (DVD), for provision.

The SB 204 serves as a bridge for connecting the NB 203 to a PCI device or a peripheral device. The ASIC 206 serves as an integrated circuit (IC) for image processing having a hardware element for image processing, and functions as a bridge that connects the AGP bus 221, a PCI bus 222, the HDD controller 208, and the MEM-C 207.

The ASIC 206 includes a PCI target, an AGP master, an arbiter (ARB) that forms the core of the ASIC 206, a memory controller that controls the MEM-C 207, a plurality of direct memory access controllers (DMAC) that rotates image data by hardware logic or the like, and a PCI unit that performs data transfer between a scan processing unit 231 and a print processing unit 232 through the PCI bus 222. Note that, for connection to the ASIC 206, an interface based on universal serial bus (USB) or an interface based on Institute of Electrical and Electronics Engineers 1394 (IEEE 1394) may be used.

The MEM-C 207 corresponds to a local memory to be used as a copy image buffer or a code buffer. The HD 209 corresponds to a storage for accumulating image data, accumulating font data to be used at the time of printing, and accumulating forms. The HD 209 controls reading of data from the HD 209 or writing of data to the HD 209 under the control of the CPU 201.

The AGP bus 221 serves as a bus interface for a graphics accelerator card designed for speeding up graphics processing. The AGP bus 221 enables direct access to the MEM-P 202 at a high throughput to speed up the graphics accelerator card.

The near-field communication circuit 220 includes a near-field communication antenna 220a. The near-field communication circuit 220 serves as a communication circuit for near-field communication (NFC) or Bluetooth (registered trademark).

Furthermore, the engine controller 230 includes the scan processing unit 231 and the print processing unit 232.

The controller 210 controls the entire image forming apparatus 1 including the printer 2. For example, the controller 210 controls drawing, communication, an input from the operation panel 70, a reader to read a result of printing, or an inspector to inspect read data. The scan processing unit 231 reads an image on a conveyance medium, such as a sheet P, to generate image data. The print processing unit 232 includes a transferer that transfers an image of color material, such as a toner image, to a conveyance medium such as a sheet P, a fixer that fixes the image, and a heater or a dryer, and performs image formation to the sheet P. Furthermore, the scan processing unit 231 or the print processing unit 232 performs image processing, such as error diffusion or gamma correction.

Note that such a sheet P is an exemplary conveyance medium. A conveyance medium is not necessarily a paper sheet and may be any medium, such as a film or a plastic sheet, which can be stored in a sheet feeding cassette included in the printer 2 and can be conveyed and output in response to an instruction for outputting a sheet P.

The network I/F 250 serves as an interface for data communication using a communication network. The near-field communication circuit 220 and the network I/F 250 are electrically connected to the ASIC 206 through the PCI bus 222.

The operation panel 70 includes a panel display 70a such as a touch panel that displays the current setting values, selection values, or modes and receives an input from a user and an operation key 70b including a numeric keypad that receives a setting value for a condition related to image formation, such as a setting value for a density condition, and a start key that receives an instruction for starting copying. The panel display 70a is an exemplary display. Note that the panel display 70a can receive a touch input from a user and thus the user can operate, with its finger or a pen, to input a numerical value to an input box, make a selection from a pull-down menu, or make a switch between ON and OFF to a check box, displayed on the screen. The operation key 70b may include an input device, such as a trackball or a touchpad, in addition to the numeric keypad.

Note that the printer 2 having an electrophotographic image forming mechanism is exemplified in FIG. 2 but may have a different image forming mechanism, such as an inkjet image forming mechanism.

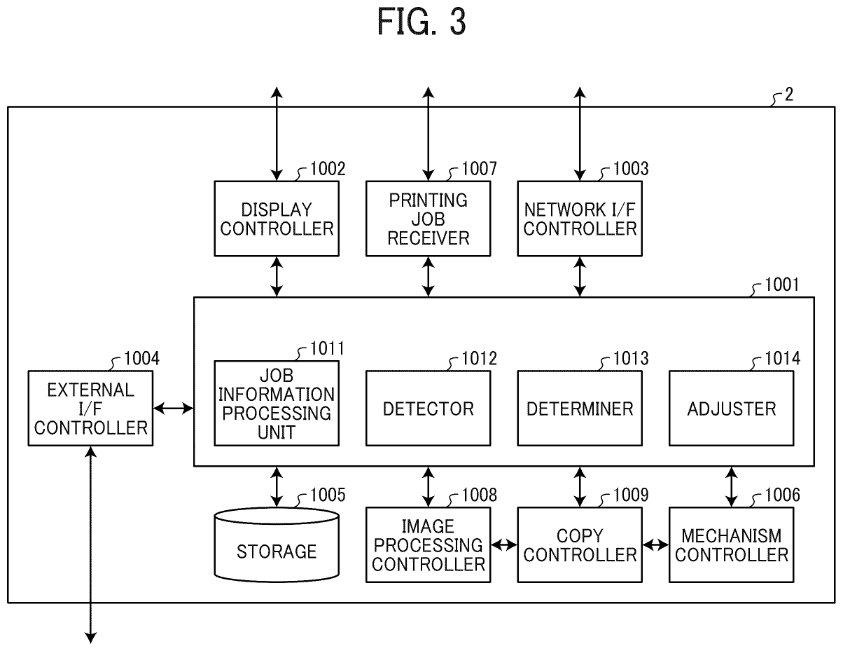

FIG. 3 illustrates exemplary functional blocks of the printer 2. The printer 2 includes a system controller 1001, a display controller 1002, a network I/F controller 1003, an external I/F controller 1004, a storage 1005, a mechanism controller 1006, a printing job receiver 1007, an image processing controller 1008, and a copy controller 1009. The CPU 201 or the ASIC 206 performs the processing prescribed by the program stored in the MEM-P 202 or the MEM-C 207 to implement the above-described constituents.

The system controller 1001 controls the entire printer 2. The system controller 1001 includes a job information processing unit 1011, a detector 1012, a determiner 1013, and an adjuster 1014.

The job information processing unit 1011 extracts job information and image data from printing job data transmitted from a DFE or the like.

The detector 1012 detects the amount of adhered toner of the toner image developed on the surface of each photoconductor 3.

More specifically, the detector 1012 detects the amount of adhered toner using the reflection density of a toner pattern detected by an optical sensor 40. The toner pattern corresponds to a test pattern for the adjuster 1014 to adjust an image formation condition.

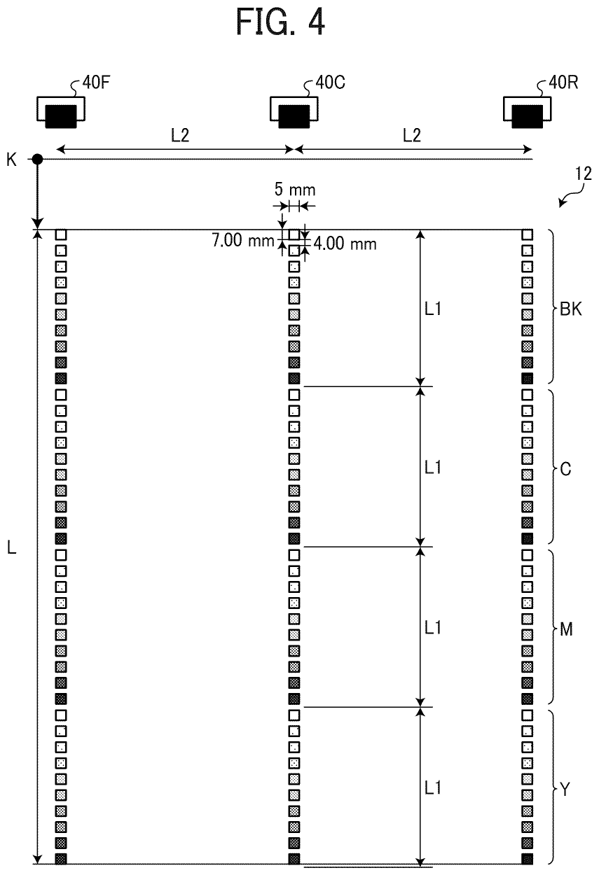

For adjustment of the image formation condition, a switch is made between the charging bias and developing bias of each developing device 6, and each photoconductor 3 is exposed with a laser beam under full irradiation and then is developed to form a gradation toner pattern (gradation pattern). The toner pattern on each photoconductor 3 is transferred to the intermediate transfer belt 12 by the corresponding transfer roller 13. FIG. 4 illustrates an exemplary toner pattern transferred to the intermediate transfer belt 12.

In general, a toner pattern means the entire gradation pattern or means each individual pattern included in the gradation pattern. Full irradiation means that the respective regions corresponding to the patterns in FIG. 4 are kept exposed with a laser beam without making dots.

Toner patterns are generated at three places of the front (F), rear (R), and center (C) on each photoconductor 3 in the direction in which the corresponding photoconductor 3 is scanned with a laser beam (hereinafter, referred to as a “main scanning direction”). That is, toner patterns are generated in end regions and a center region in a direction orthogonal to the direction of movement of the intermediate transfer belt 12. Referring to FIG. 4, in each region, black, cyan, magenta, and yellow toner patterns in order from above are each formed of ten patterns different in density.

A reduction in the size of a pattern causes a reduction in toner consumption. Each pattern in the present embodiment is rectangular and has a length of 5 mm in the main scanning direction and a length of 7 mm in a sub-scanning direction that corresponds to the direction of movement of the intermediate transfer belt 12 and is orthogonal to the main scanning direction. The interval between patterns in the sub-scanning direction is 4 mm. The total length L of gradation patterns is 434 mm, and the pitch L1 between each photoconductor is 110 mm.

The reflection densities of the toner patterns are detected by reflective optical sensors 40F, 40C, and 40R.

The indices F, C, and R for 40F, 40C, and 40R represent the front, center, and rear positions in the main scanning direction, respectively.

Hereinafter, the indices will be omitted as appropriate. As illustrated in FIG. 4, the optical sensor 40C is installed to detect pattern density in the center region. The distance L2 between the optical sensor 40C and each of the optical sensors 40F and 40R is 160 mm. Referring to FIG. 4, K represents a criterial point.

A region for sensor detection is desirably 2 mm or less. In the present embodiment, as illustrated in FIG. 4, the length in the sub-scanning direction of each pattern is 7 mm but may be approximately 5 mm in consideration of the number of data samples or the accuracy of detecting pattern edges. Preferably, the length in the sub-scanning direction of each pattern ranges between 5 and 7 mm. The reflection density of each pattern can be obtained by pattern sensor output. Based on the reflection densities of the patterns, the detector 1012 detects the amount of adhered toner of the toner image developed on the surface of each photoconductor 3.

Based on the job information extracted by the job information processing unit 1011, the determiner 1013 determines an adjustment operation for the image formation condition as described below.

The adjuster 1014 adjusts the image formation condition using the detected amount of adhered toner and the determined adjustment operation. The image formation condition includes the respective charging biases to be applied to the charging rollers 4, the exposure energy of light to be emitted by the exposure device 8, and the respective developing biases to be applied to the developing rollers 5. The image formation condition is adjusted by the adjustment operation.

Next, the adjustment processing of the adjuster 1014 will be described. In general, according to the image forming apparatus 1, even when image density is detected and then density correction is performed, the density varies temporally and thus a deterioration may be made in image stability. In particular, for example, when the image forming apparatus 1 has not been used for a long term, the density tends to vary. At the time of power-on of the image forming apparatus 1 or at the time of recovery of the image forming apparatus 1 from the energy-saving mode, the image formation condition is adjusted to adjust image density, leading to image stability.

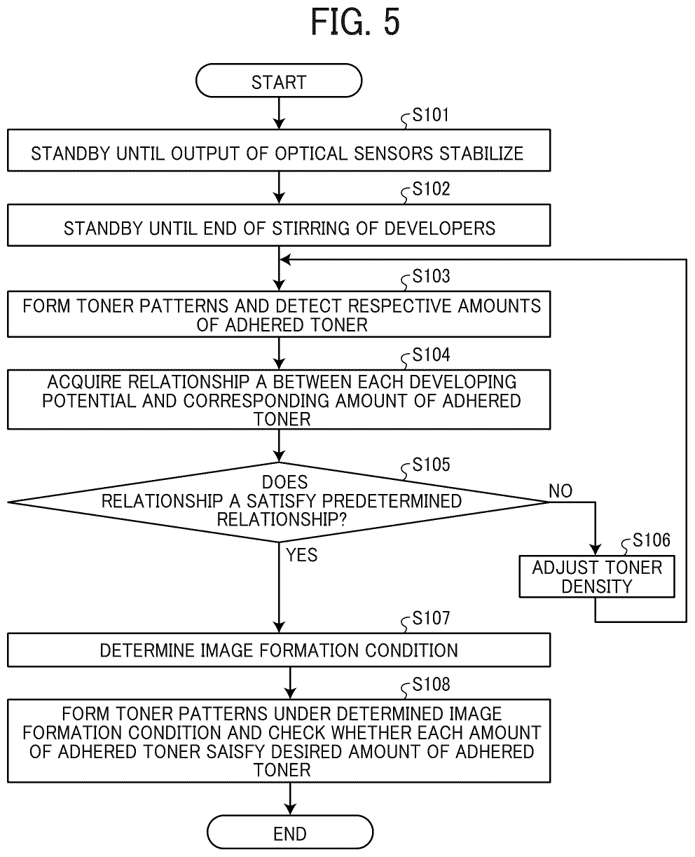

FIG. 5 is a flowchart illustrating an exemplary adjustment operation including all operations. First, the adjuster 1014 remains on standby until the outputs of the optical sensors 40 stabilize after power-on of the optical sensors 40 based on startup of the print processing unit 232 (step S101) and remains on standby until stirring of the developers is finished (step S102).

Next, the controller 210 forms toner patterns, and the detector 1012 detects the respective amounts of adhered toner of the formed toner patterns (step S103). Subsequently, the adjuster 1014 acquires a relationship A between the developing potential at the time of formation of each pattern (difference between the developing bias and a potential of the surface of the image bearer) and the amount of adhered toner (step S104). The potential of the surface of the image bearer may be referred to also1 as a “surface potential”.

The relationship A is, for example, the gradient γ of an approximated straight line obtained using a least squares method from the relationship, between the developing potential at the time of formation of each pattern and the amount of adhered toner, plotted on an X-Y plane.

When the relationship A acquired by the adjuster 1014 has not satisfied a predetermined relationship (No in step S105), the controller 210 adjusts toner density and then the processing goes back to step S103 (step S106). Then, steps S103 to S106 are repeated until the relationship A satisfies the predetermined relationship.

For example, the controller 210 can supply or consume toner to adjust the toner density of the corresponding developer. The gradient γ of the approximated straight line described above can be controlled by a variation in toner density. For example, when the gradient γ is larger than a target value, a decrease is made in toner density. When the gradient γ is smaller than the target value, an increase is made in toner density. Thus, the gradient γ can be made closer to the target value.

On the other hand, when the relationship A acquired by the adjuster 1014 has satisfied the predetermined relationship (Yes in step S105), the adjuster 1014 calculates a developing potential for a target amount of adhered toner, based on the relationship A (e.g., the above-described approximated straight line), and determines an image formation condition (charging bias, exposure energy, and developing bias) for the developing potential (step S107).

Finally, the controller 210 forms toner patterns under the determined image formation condition, and the adjuster 1014 verifies whether each amount of adhered toner detected by the detector 1012 has satisfied a desired value (step S108).

Due to the above procedure, at the time of power-on of the image forming apparatus 1 or at the time of recovery of the image forming apparatus 1 from the energy-saving mode, the image formation condition is adjusted. However, it takes more time when all the operations included in the adjustment operation described above are performed than when printing is performed after adjustment. However, an operation skippable (excludable) depending on the content of the job information is included. In the present embodiment, when the job information has satisfied a predetermined condition, the determiner 1013 excludes a predetermined operation from the adjustment operation.

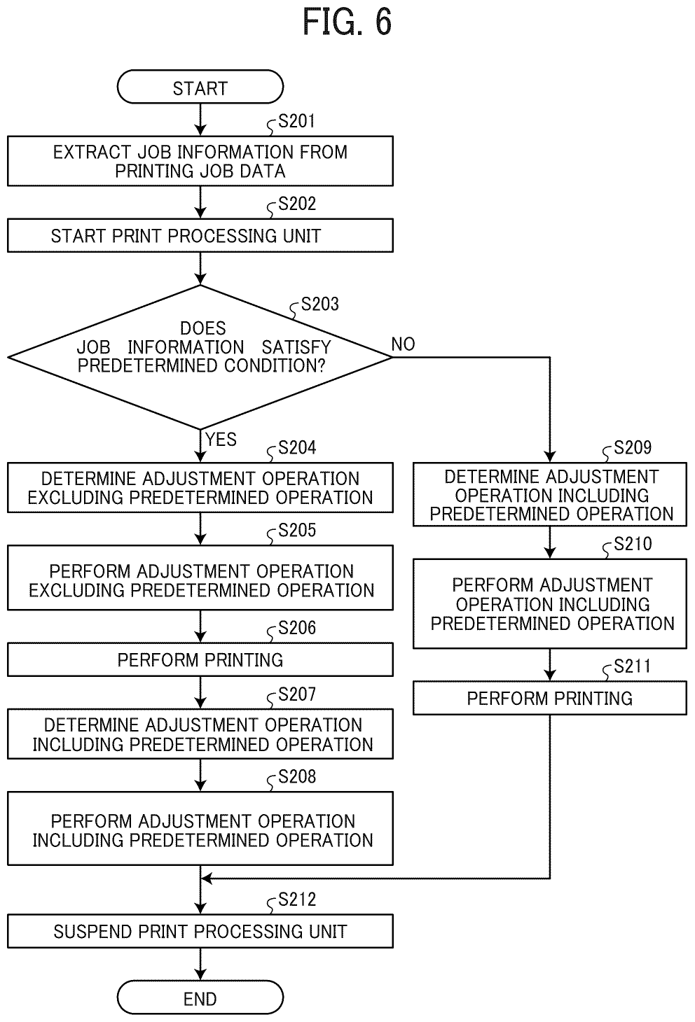

FIG. 6 is a flowchart illustrating an exemplary adjustment procedure according to the present embodiment. First, at the time of power-on of the image forming apparatus 1 or at the time of recovery of the image forming apparatus 1 from the energy-saving mode, the job information processing unit 1011 extracts job information from printing job data (step S201), and the controller 210 starts up the print processing unit 232 (step S202).

Next, the determiner 1013 determines whether or not the extracted job information has satisfied the predetermined condition. When the determination indicates that the extracted job information has satisfied the predetermined condition (Yes in step S203), the determiner 1013 determines an adjustment operation excluding a predetermined operation (step S204). On the other hand, when the determination indicates that the extracted job information has not satisfied the predetermined condition (No in step S203), the determiner 1013 determines an adjustment operation not excluding the predetermined operation (ordinary adjustment operation) (step S209).

The predetermined condition includes a condition that the sheet type indicated by the job information is plain paper and a condition that the print type indicated by the job information is monochrome printing. For example, image stability is less required when the sheet type is plain paper than when the sheet type is glossy paper, matte paper, or uneven paper because character printing is mainly performed to plain paper. Similarly, image stability is less required when the print type is monochrome printing because character printing is mainly performed in monochrome printing. As above, when it can be determined that the job requires less image stability, based on the job information, the predetermined operation is excluded from the adjustment operation, leading to a reduction in the time taken for adjustment. That is, for printing to plain paper or monochrome printing, fast print time, namely, a reduction in waiting time can be made prior to image stability. Thus, a reduction can be made in waiting time for a user.

For example, the predetermined operation to be excluded includes at least any of the following operations, which are included in the procedure of the adjustment operation in FIG. 5.
(1) An operation of standing by until the outputs of the optical sensors, which each detect toner density, stabilize (step S101 in FIG. 5).
(2) An operation of determining whether or not the relationship between each developing potential and the corresponding amount of adhered toner has satisfied the predetermined relationship (steps S104 and S105 in FIG. 5).
(3) An operation of adjusting toner density when the relationship between any of the developing potentials and the corresponding amount of adhered toner has not satisfied the predetermined relationship (step S106 and repetition of steps S103 to S105 in FIG. 5).
(4) An operation of checking whether the amount of adhered toner of a test pattern formed under the image formation condition determined based on the relationship between each developing potential and the corresponding amount of adhered toner has satisfied a predetermined amount of adhesion (step S108 in FIG. 5).

Note that the predetermined operation may include all the operations (1) to (4) or may include any of the operations (1) to (4). The predetermined operation may be changed depending on the predetermined condition. For example, when image stability is less required when the print type is monochrome printing than when the sheet type is plain paper, the predetermined operation for the former case may include any of the operations (1) to (4) and the predetermined operation for the latter case may include all the operations (1) to (4). The predetermined operation for plain paper and monochrome printing may include all the operations (1) to (4). The predetermined operation for any sheet type different from plain paper and monochrome printing or the predetermined operation for plain paper and color printing may include any of the operations (1) to (4).

When the predetermined condition has been satisfied, the adjuster 1014 performs the adjustment operation excluding the predetermined operation to adjust the image formation condition (step S205). Thus, a reduction is made in waiting time. After printing is performed (step S206), the determiner 1013 determines an adjustment operation not excluding the predetermined operation (step S207). The adjuster 1014 performs the adjustment operation not excluding the predetermined operation (ordinary adjustment operation) to adjust the image formation condition (step S208). Thus, even when the predetermined condition has been satisfied, after the first job printing is performed, the ordinary adjustment is performed. Thereafter, printing is performed with image stability regardless of any job. Note that, in the present embodiment, steps S207 and S208 described above may be omitted.

On the other hand, when the predetermined condition has not been satisfied, the adjuster 1014 performs an adjustment operation not excluding the predetermined operation to adjust the image formation condition (step S210), and then printing is performed (step S211). As above, in the present embodiment, in accordance with the job information, an adjustment operation is determined for the image formation condition, and the image formation condition is adjusted.

After the processing in step S208 or the processing in step S211, the controller 210 suspends the print processing unit 232 (step S212). Note that, in step S212, the print processing unit 232 may be brought in a state, such as in sleep mode, in standby mode, or in energy-saving mode.

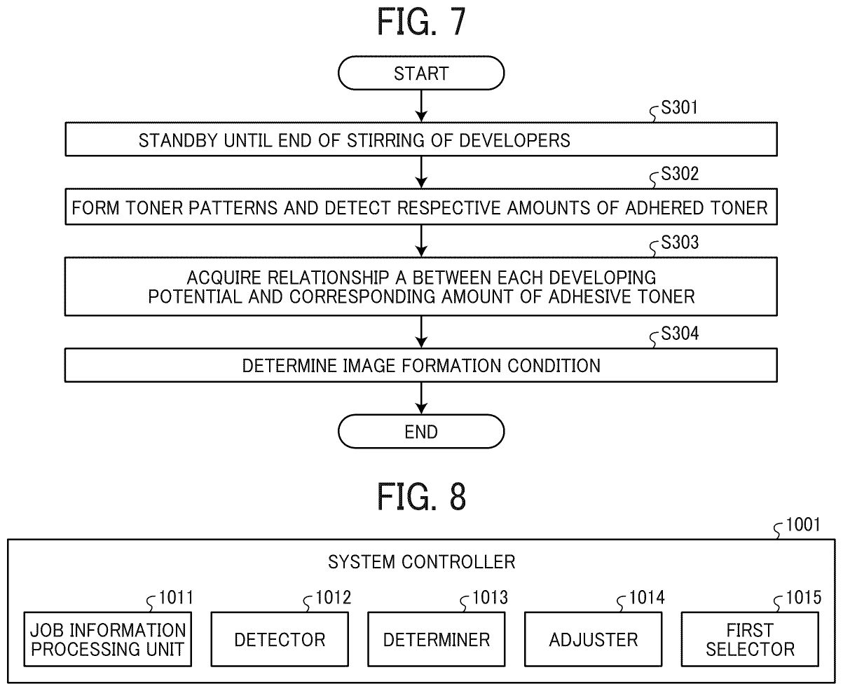

FIG. 7 is a flowchart illustrating an exemplary adjustment operation excluding the predetermined operation. In this example, all the operations (1) to (4) described above are excluded (skipped) from the adjustment operation.

First, the adjuster 1014 remains on standby until stirring of the developers is finished (step S301). Next, the controller 210 forms toner patterns, and the detector 1012 detects the amount of adhered toner of each formed toner pattern, based on the respective outputs from the optical sensors 40 (step S302). Subsequently, the adjuster 1014 acquires the relationship A between the developing potential at the time of formation of each pattern and the amount of adhered toner (step S303). Then, the adjuster 1014 calculates a developing potential for the target amount of adhered toner using the acquired relationship A and determines an image formation condition for the developing potential (step S304).

In the adjustment operation described with FIG. 7, the adjuster 1014 does not wait for the optical sensors to stabilize their outputs. In addition, even when the relationship between any of the developing potentials and the corresponding amount of adhered toner has not satisfied the predetermined relationship, no adjustment of toner density and no re-formation of toner patterns are performed. Furthermore, no formation of toner patterns under the determined image formation condition and no verification of toner patterns are performed. Thus, the time taken for the adjustment operation described with FIG. 7 is significantly shorter than the time taken for the ordinary adjustment operation described with FIG. 5.

As above, according to the present embodiment, when the job requires less image stability at the time of power-on or at the time of recovery from the energy-saving mode, part of the adjustment operation is skipped. Thus, printing can start promptly. When part of the adjustment operation is skipped, the ordinary adjustment is performed with no skip after the job is finished. Thereafter, printing can be performed at desired image density.

### Second Embodiment

According to a second embodiment, a predetermined condition for excluding part of an adjustment operation can be selected from a plurality of conditions. Differences between the second embodiment and the first embodiment will be described below, but description of the overlaps between the second embodiment and the first embodiment will be omitted.

FIG. 8 illustrates an exemplary functional configuration of a system controller 1001. Differently from the first embodiment, the system controller 1001 includes a first selector 1015, and a determiner 1013 excludes part of the adjustment operation, based on the predetermined condition selected by the first selector 1015.

The first selector 1015 selects, from a plurality of conditions, a predetermined condition for excluding part of the adjustment operation. The plurality of conditions includes a printing condition requiring less image stability. For example, the plurality of conditions includes a condition that the sheet type indicated by job information is plain paper and a condition that the print type indicated by the job information is monochrome printing. The plurality of conditions may include three or more conditions. For example, in addition to the above-described two conditions, a condition that the print type indicated by the job information is draft printing may be included.

The first selector 1015 selects, as the predetermined condition, the condition selected by a user through an operation panel 70 or the like. Then, the determiner 1013 determines an adjustment operation for an image formation condition, based on the job information extracted by a job information processing unit 1011 and the predetermined condition selected by the first selector 1015. Specifically, when the job information has satisfied the predetermined condition, a predetermined operation is excluded from the adjustment operation. When the job information has not satisfied the predetermined condition, an adjustment operation not excluding the predetermined operation, namely, the ordinary adjustment operation is determined. Note that the predetermined operation to be excluded may be the same between the plurality of conditions or may vary per condition.

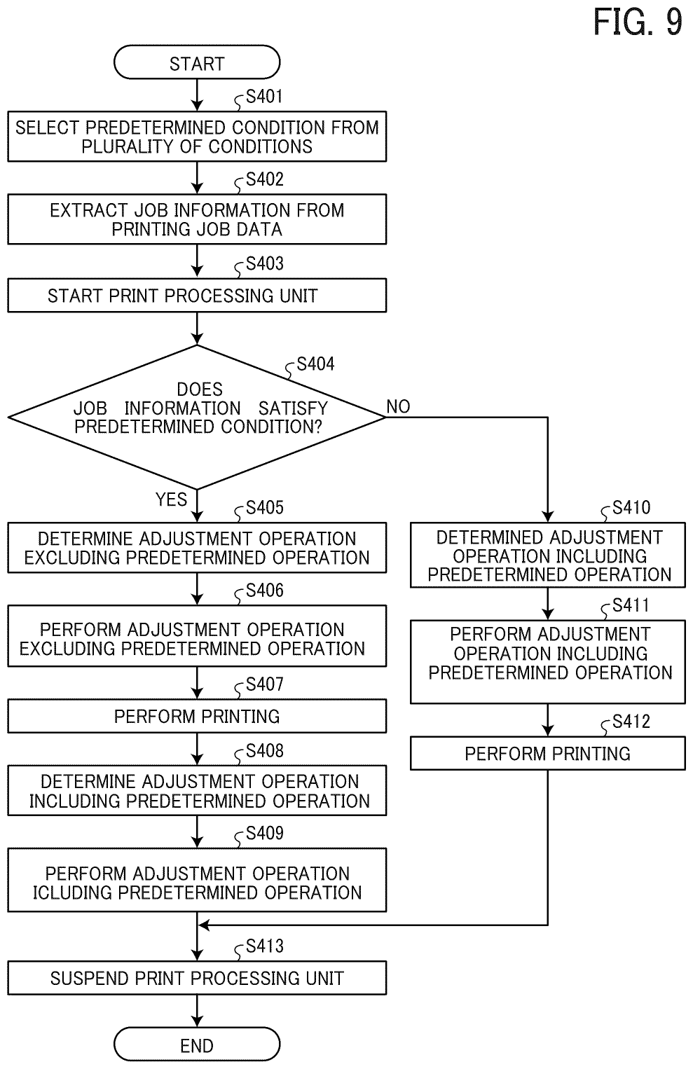

FIG. 9 is a flowchart illustrating an exemplary adjustment procedure according to the present embodiment. First, the first selector 1015 selects the predetermined condition from the plurality of conditions (step S401). Although steps S402 to S413 correspond to steps S201 to S212 described with FIG. 6 in the first embodiment, in step S404, it is determined whether or not the job information has satisfied the predetermined condition selected in step S401. The other operations are similar to the operations in the first embodiment and thus descriptions thereof will be omitted.

As above, according to the present embodiment, the predetermined condition for excluding part of the adjustment operation can be selected from the plurality of conditions. Thus, a condition that fast print time is prioritized in response to a request from the user can be selected.

### Third Embodiment

According to a third embodiment, whether or not part of an adjustment operation be excluded can be selected in advance in accordance with job information. Differences between the third embodiment and the first embodiment will be described below, but description of the overlaps between the third embodiment and the first embodiment will be omitted.

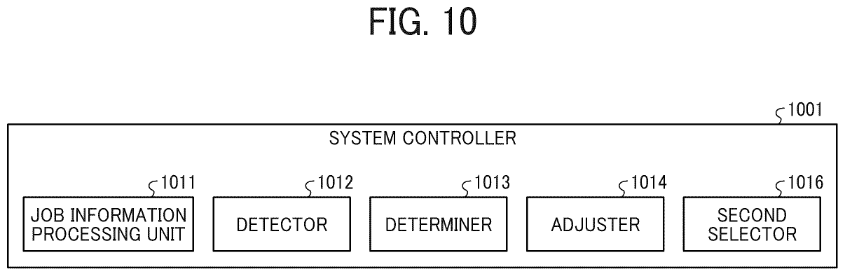

FIG. 10 illustrates an exemplary functional configuration of a system controller 1001. Differently from the first embodiment, the system controller 1001 includes a second selector 1016, and a determiner 1013 determines an adjustment operation, based on the mode selected by the second selector 1016.

The second selector 1016 selects either a first mode or a second mode. In the first mode, when the job information has satisfied a predetermined condition, the determiner 1013 excludes a predetermined operation from the adjustment operation. In the second mode, regardless of the content of the job information, the determiner 1013 determines the ordinary adjustment operation as an adjustment operation. That is, the skipping to the adjustment operation described in the first embodiment is on in the first mode, and the skipping to the adjustment operation described in the first embodiment is off in the second mode.

The second selector 1016 selects either the first mode or the second mode, based on an operation from a user through an operation panel 70 or the like. Then, when the first mode has been selected, the determiner 1013 determined an adjustment operation for the image formation condition described in the first embodiment, based on the job information extracted by a job information processing unit 1011 and the predetermined condition. When the second mode has been selected, the determiner 1013 determines, as an adjustment operation, the ordinary adjustment operation not excluding the predetermined operation, regardless of the job information.

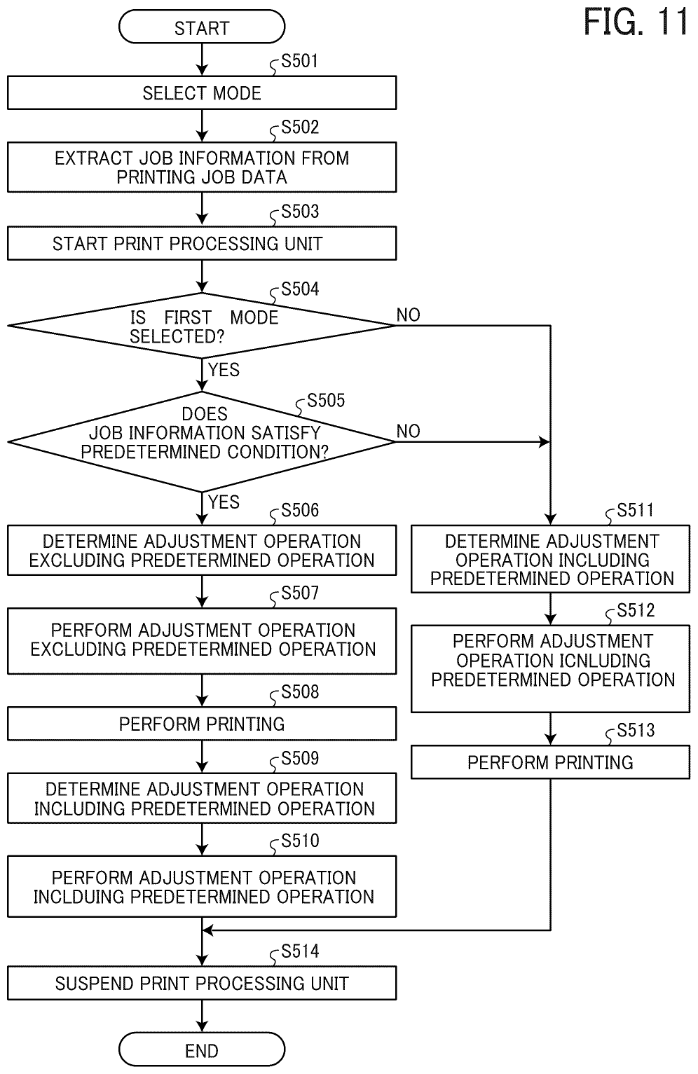

FIG. 11 is a flowchart illustrating an exemplary adjustment procedure according to the present embodiment. First, the second selector 1016 selects the first mode or the second mode (step S501). The operations in steps S502 and S503 are similar to the operations in steps S201 and S202 described with FIG. 6 in the first embodiment.

Next, a controller 210 causes the processing to proceed to step S505 when the first mode has been selected (Yes in step S504) or causes the processing to proceed to step S511 when the second mode has been selected (No in step S504). The other operations in steps S505 to S514 are similar to the operations in steps S203 to S212 described with FIG. 6 in the first embodiment.

As above, according to the present embodiment, either the mode for turning on the skipping to the adjustment operation or the mode for turning off the skipping to the adjustment operation can be selected. Thus, whether fast print time or image stability be prioritized in response to a request from the user can be selected in advance.

Some embodiments of the present embodiment have been described above, and the embodiments described above are just exemplary and are not intended to limit the scope of the present embodiment. For example, the function of a determiner 1013, the function of a first selector 1015, or the function of a second selector 1016 may be provided to an operation panel 70, instead of being provided to a system controller 1001 in a printer 2. Such novel embodiments can be carried out in other various modes and thus various omissions, replacements, and alterations can be made without departing from the gist of the present embodiment. The novel embodiments and modifications thereof are included in the scope and gist of the present embodiment and additionally are included in the scope of the present embodiment in the claims and the equivalents thereof. Furthermore, some constituent elements in different embodiments and modifications may be combined as appropriate.

The program to be executed in the image forming apparatus 1 according to each embodiment described above is recorded, in an installable file format or in an executable file format, on a computer-readable recording medium, such as a compact disc read only memory (CD-ROM), a flexible disk (FD), a compact disc recordable (CD-R), or a digital versatile disc (DVD), for provision.

The program to be executed in the image forming apparatus 1 according to each embodiment may be stored on a computer connected to a network, such as the Internet, and may be downloaded through the network for provision. The program to be executed in the image forming apparatus 1 according to each embodiment may be provided or distributed through a network, such as the Internet.

The program in each embodiment may be preloaded on a ROM for provision.

The program to be executed in the image forming apparatus 1 according to each embodiment has a module configuration including the above-described constituents (e.g., the job information processing unit 1011, the detector 1012, the determiner 1013, and the adjuster 1014). As actual hardware, the CPU (processor) reads the program from the recording medium and then executes the program to load the above-described constituents onto the main storage, so that the job information processing unit 1011, the detector 1012, the determiner 1013, the adjuster 1014, and the like are generated on the main storage.

Each function in each embodiment described above, such as the detector 1012, the determiner 1013, and the adjuster 1014, can be implemented by a single processing circuit or a plurality of processing circuits. The term “processing circuit” herein includes a processor programmed to perform each function by software, such as a processor implemented by an electronic circuit, and devices, such as an ASIC, a digital signal processor (DSP), a field programmable gate array (FPGA), and conventional circuit modules, which are designed to perform the above-described functions.

An image forming apparatus includes: an image bearer to adhere toner on a surface of the image bearer to form a toner image of the image bearer according to image data in printing job data; a detector to detect an amount of the toner adhered on the surface of the image bearer; circuitry configured to: determine an adjustment operation to adjust an image formation condition to form the toner image on the image bearer based on job information in the printing job data; perform the adjustment operation to adjust the image formation condition based on the amount of toner detected by the detector; and exclude a predetermined operation from the adjustment operation when the job information satisfies a predetermined condition.

The circuitry is further configured to, when the job information satisfies the predetermined condition: perform printing with the image formation condition adjusted by the adjustment operation; determine the adjustment operation including the predetermined operation after performing the printing; and perform the adjustment operation including the predetermined operation to adjust the image formation condition.

The image forming apparatus further includes: a charging roller to charge the surface of the image bearer with a charging bias; an exposure device to emit light with exposure energy onto the surface of the image bearer to form a latent image on the image bearer; and a developing roller, applied with a developing bias, to develop the toner image on the surface of the image bearer. The circuitry is further configured to adjust, as the image formation condition: the charging bias to be applied to the charging roller; the exposure energy of light to be emitted by the exposure device; and the developing bias to be applied to the developing roller.

The image forming apparatus further includes an optical sensor to detect toner density of the toner on the surface of the image bearer, wherein the circuitry is further configured to exclude, from the adjustment operation, the predetermined operation including at least one of: standing by until an output of the optical sensor stabilizes; determining whether the amount of toner and a developing potential satisfy a predetermined relationship, the developing potential being a difference between the developing bias and a surface potential of the surface of the image bearer; adjusting the toner density when the developing potential and the amount of toner do not satisfy the predetermined relationship; or checking whether an amount of toner of a test pattern satisfies a predetermined amount of toner, and the test pattern is formed on the surface of the image bearer under the image formation condition determined based on a relationship between the developing potential and the amount of the toner.

The circuitry is further configured to: perform the predetermined operation including the predetermined operation in the adjustment operation when the job information including a printing job of a first image stability; and perform the predetermined operation excluding the predetermined operation from the adjustment operation when the job information including the printing job of a second image stability less than the first image stability. The circuitry is further configured to exclude the predetermined operation from the adjustment operation when the job information including a sheet type of a plain paper. The circuitry is further configured to exclude the predetermined operation from the adjustment operation when the job information including a print type of a monochrome printing.

The image forming apparatus further includes an operation panel to select a mode of the adjustment operation, and the circuitry is further configured to perform, according to the mode selected by the operation panel, either one of: a first mode in which the circuitry excludes the predetermined operation from the adjustment operation when the job information satisfies the predetermined condition; or a second mode in which the circuitry performs the adjustment operation including the predetermined operation, regardless of the job information.

An image forming method includes: adhering toner on a surface of an image bearer to form a toner image on the image bearer according to image data in printing job data; detecting an amount of the toner adhered on the surface of the image bearer; determining an adjustment operation to adjust an image formation condition to form the toner image on the image bearer based on job information in the printing job data; performing the adjustment operation to adjust the image formation condition based on the amount of toner detected; and excluding a predetermined operation from the adjustment operation when the job information satisfies a predetermined condition.

A non-transitory recording medium storing a program for causing a computer to perform: adhering toner on a surface of an image bearer to form a toner image on the image bearer according to image data in printing job data; detecting an amount of the toner adhered on the surface of the image bearer; determining an adjustment operation to adjust an image formation condition to form the toner image on the image bearer based on job information in the printing job data; performing the adjustment operation to adjust the image formation condition based on the amount of toner detected; and excluding a predetermined operation from the adjustment operation when the job information satisfies a predetermined condition.

According to the present embodiment, as an effect, at the time of power-on or at the time of recovery from energy-saving mode, printing can start promptly when an adjustment operation includes an omittable operation, depending on a printing job.

Aspects of the present embodiment are, for example, as follows.

According to Aspect 1, an image forming apparatus includes: a detector to detect an amount of adhered toner of a toner image developed on a surface of an image bearer; a determiner to determine an adjustment operation for an image formation condition, based on job information as information on a printing job; and an adjuster to adjust the image formation condition using the amount of adhered toner detected by the detector and the adjustment operation determined by the determiner, the determiner being to exclude a predetermined operation from the adjustment operation when the job information satisfies a predetermined condition.

According to Aspect 2, in the image forming apparatus of Aspect 1, when the job information satisfies the predetermined condition, the determiner determines the adjustment operation not excluding the predetermined operation after printing is performed, and the adjuster adjusts the image formation condition using the adjustment operation not excluding the predetermined operation.

According to Aspect 3, the image forming apparatus of Aspect 1 or 2 further includes: a charging roller to charge the surface of the image bearer; an exposure device to form a latent image on the image bearer; and a developing roller to develop the toner image on the surface of the image bearer, in which the adjuster adjusts, as the image formation condition, a charging bias to be applied to the charging roller, an exposure energy of light to be emitted by the exposure device, and a developing bias to be applied to the developing roller.

According to Aspect 4, in the image forming apparatus of Aspect 3, the predetermined operation to be excluded from the adjustment operation includes at least any of an operation of standing by until an output of an optical sensor to detect toner density stabilizes, an operation of determining whether or not a relationship between a developing potential that is a difference between the developing bias and a potential of the surface of the image bearer and the amount of adhered toner satisfies a predetermined relationship, an operation of adjusting the toner density when the relationship between the developing potential and the amount of adhered toner does not satisfy the predetermined relationship, or an operation of checking whether an amount of adhered toner of a test pattern formed under the image formation condition determined based on the relationship between the developing potential and the amount of adhered toner satisfies a predetermined amount of adhesion.

According to Aspect 5, in the image forming apparatus of any one of Aspects 1 to 4, the determiner excludes the predetermined operation from the adjustment operation when the job information indicates that the printing job requires less image stability.

According to Aspect 6, in the image forming apparatus of any one of Aspects 1 to 4, the determiner excludes the predetermined operation from the adjustment operation when a sheet type indicated by the job information is plain paper.

According to Aspect 7, in the image forming apparatus of any one of Aspects 1 to 4, the determiner excludes the predetermined operation from the adjustment operation when a print type indicated by the job information is monochrome printing.

According to Aspect 8, the image forming apparatus of any one of Aspects 1 to 7 further includes a first selector to select the predetermined condition from a plurality of conditions, in which the plurality of conditions includes a condition that a sheet type indicated by the job information is plain paper and a condition that a print type indicated by the job information is monochrome printing.

According to Aspect 9, the image forming apparatus of any one of Aspects 1 to 8 further includes a second selector to select either a first mode in which the determiner excludes the predetermined operation from the adjustment operation when the job information satisfies the predetermined condition or a second mode in which the determiner does not exclude the predetermined operation from the adjustment operation, regardless of the job information.

According to Aspect 10, an image forming method to be performed by an image forming apparatus includes: detecting an amount of adhered toner of a toner image developed on a surface of an image bearer; determining an adjustment operation for an image formation condition, based on job information as information on a printing job; and adjusting the image formation condition using the detected amount of adhered toner and the determined adjustment operation, the determining including excluding a predetermined operation from the adjustment operation when the job information satisfies a predetermined condition.

According to Aspect 11, a non-transitory recording medium stores a program for causing a computer to function as: a detector to detect an amount of adhered toner of a toner image developed on a surface of an image bearer; a determiner to determine an adjustment operation for an image formation condition, based on job information as information on a printing job; and an adjuster to adjust the image formation condition using the amount of adhered toner detected by the detector and the adjustment operation determined by the determiner, the determiner being to exclude a predetermined operation from the adjustment operation when the job information satisfies a predetermined condition.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An image forming apparatus comprising:
an image bearer to adhere toner on a surface of the image bearer to form a toner image of the image bearer according to image data in printing job data;
a detector to detect an amount of the toner adhered on the surface of the image bearer; circuitry configured to:
determine an adjustment operation to adjust an image formation condition to form the toner image on the image bearer based on job information in the printing job data;
perform the adjustment operation to adjust the image formation condition based on the amount of toner detected by the detector; and
exclude a predetermined operation from the adjustment operation when the job information satisfies a predetermined condition.

2. The image forming apparatus according to claim 1,
wherein the circuitry is further configured to, when the job information satisfies the predetermined condition:
perform printing with the image formation condition adjusted by the adjustment operation;
determine the adjustment operation including the predetermined operation after performing the printing; and
perform the adjustment operation including the predetermined operation to adjust the image formation condition.

3. The image forming apparatus according to claim 1, further comprising:
a charging roller to charge the surface of the image bearer with a charging bias;
an exposure device to emit light with exposure energy onto the surface of the image bearer to form a latent image on the image bearer; and
a developing roller, applied with a developing bias, to develop the toner image on the surface of the image bearer,
wherein the circuitry is further configured to adjust, as the image formation condition:
the charging bias to be applied to the charging roller;
the exposure energy of light to be emitted by the exposure device; and
the developing bias to be applied to the developing roller.

4. The image forming apparatus according to claim 3, further comprising an optical sensor to detect toner density of the toner on the surface of the image bearer,
wherein the circuitry is further configured to exclude, from the adjustment operation, the predetermined operation including at least one of:
standing by until an output of the optical sensor stabilizes;
determining whether the amount of toner and a developing potential satisfy a predetermined relationship, the developing potential being a difference between the developing bias and a surface potential of the surface of the image bearer;
adjusting the toner density when the developing potential and the amount of toner do not satisfy the predetermined relationship; or
checking whether an amount of toner of a test pattern satisfies a predetermined amount of toner, and
the test pattern is formed on the surface of the image bearer under the image formation condition determined based on a relationship between the developing potential and the amount of the toner.

5. The image forming apparatus according to claim 1,
wherein the circuitry is further configured to:
perform the predetermined operation including the predetermined operation in the adjustment operation when the job information including a printing job of a first image stability; and
perform the predetermined operation excluding the predetermined operation from the adjustment operation when the job information including the printing job of a second image stability less than the first image stability.

6. The image forming apparatus according to claim 1,
wherein the circuitry is further configured to exclude the predetermined operation from the adjustment operation when the job information including a sheet type of a plain paper.

7. The image forming apparatus according to claim 1,
wherein the circuitry is further configured to exclude the predetermined operation from the adjustment operation when the job information including a print type of a monochrome printing.

8. The image forming apparatus according to claim 1, further comprising an operation panel to select a mode of the adjustment operation,
wherein the circuitry is further configured to perform, according to the mode selected by the operation panel, either one of:
a first mode in which the circuitry excludes the predetermined operation from the adjustment operation when the job information satisfies the predetermined condition; or
a second mode in which the circuitry performs the adjustment operation including the predetermined operation, regardless of the job information.

9. An image forming method comprising:
adhering toner on a surface of an image bearer to form a toner image on the image bearer according to image data in printing job data;
detecting an amount of the toner adhered on the surface of the image bearer;
determining an adjustment operation to adjust an image formation condition to form the toner image on the image bearer based on job information in the printing job data;
performing the adjustment operation to adjust the image formation condition based on the amount of toner detected; and
excluding a predetermined operation from the adjustment operation when the job information satisfies a predetermined condition.

10. A non-transitory recording medium storing a program for causing a computer to perform:
adhering toner on a surface of an image bearer to form a toner image on the image bearer according to image data in printing job data;
detecting an amount of the toner adhered on the surface of the image bearer;
determining an adjustment operation to adjust an image formation condition to form the toner image on the image bearer based on job information in the printing job data;
performing the adjustment operation to adjust the image formation condition based on the amount of toner detected; and
excluding a predetermined operation from the adjustment operation when the job information satisfies a predetermined condition.
